(19) United States
(12) Patent Application Publication
(10) Pub. No.: US 2026/0069479 A1
(43) Pub. Date: Mar. 12, 2026

(54) Suspension auxiliary device

(71) Applicant: Sports Art Industrial Co., Ltd., Tainan City (TW)

(72) Inventor: Hai-Pin KUO, Tainan City (TW)

(21) Appl. No.: 19/317,111

(22) Filed: Sep. 2, 2025

(30) Foreign Application Priority Data
Sep. 3, 2024 (TW) 113133163

(51) Int. Cl. A61G 7/10

(52) U.S. Cl. CPC A61G 7/1017; A61G 7/1046

(57) ABSTRACT

A suspension auxiliary device is applicable for a movable exercise apparatus in a fixed state and contains a base. The base includes two spaced rods, a coupling column, an end of an adjustment column is rotatably connected with the coupling column, and the other end of the adjustment column is rotatably connected on the base. The adjustment column is pulled via a fixing bolt so as to manually adjust a vertical moving position of the two spaced rods, and the fixing bolt is fixed so that the two spaced rods are fixed on a predetermined position. The base includes a transmission mechanism which has two hooks, such that the suspension auxiliary device hangs and supports a part or a whole weight of the user, and the users whose lower limbs cannot bear a heavy weight can perform exercise or rehabilitation training on a movable exercise apparatus by themselves.

### TECHNICAL FIELD

The present invention relates to a suspension auxiliary device which is applicable for a movable exercise apparatus in a fixed state.

### BACKGROUND

While the nature of indoor exercise equipment differs from that of outdoor sports, currently, various types of indoor exercise equipment can train various muscles in the body, allowing consumers to train and achieve fitness goals while at home or indoors. However, most indoor exercise equipment only provides fitness training for general users and is not suitable for exercise or rehabilitation training for those who cannot bear heavy weights on their lower limbs.

However, elderly individuals or rehabilitation patients require additional assistance during strength training, as they are weaker and more fragile than the average user. This assistance is crucial for ensuring the correct and smooth execution of the exercise. Beyond assisting the rehabilitation patient with the correct movements, it is also crucial to ensure their safety to prevent accidents such as falls, injuries, and collisions, leading to a shortage of adequate personnel.

The present invention has arisen to mitigate and/or obviate the afore-described disadvantages.

### SUMMARY OF THE INVENTION

The primary aspect of the present invention is to provide a suspension auxiliary device which is applicable for a movable exercise apparatus in a fixed state, the motor is controlled to rotate by using the controller so that a length of the two steel cables of the suspension auxiliary device is adjustable, and the two hooks of the two distal ends of the two steel cables descend slowly, then the two hooks hook and upward pull the sling carrier of the user so that the user moves forward. Thereafter, the suspension auxiliary device hangs and supports the part or whole weight of the user so that the using safety of the user is enhanced, and the load-bearing capacity of the lower limbs of the user is decreased by using the suspension auxiliary device, thus exercising or rehabilitating on the movable exercise apparatus for the user, the lower limbs of which cannot bear his/her heavy weight. When the user moves to the operating position of the movable exercise apparatus, the value of the pulling force of the two steel cables of the transmission mechanism is adjustably reset based on the load-bearing capacity of the lower limbs of the user.

### BRIEF DESCRIPTION OF THE DRAWINGS

FIG. 1 is a perspective view showing the assembly of a suspension auxiliary device according to a preferred embodiment of the present invention.

FIG. 2 is a perspective view showing the assembly of the transmission mechanism of the suspension auxiliary device according to the preferred embodiment of the present invention.

FIG. 3 is a side plan view showing the operation of the suspension auxiliary device according to the preferred embodiment of the present invention.

FIG. 4 is a perspective view showing the operation of the transmission mechanism of the suspension auxiliary device according to the preferred embodiment of the present invention.

FIG. 5 is another perspective view showing the operation of the transmission mechanism of the suspension auxiliary device according to the preferred embodiment of the present invention.

FIG. 6 is another perspective view showing the operation of the transmission mechanism of the suspension auxiliary device according to the preferred embodiment of the present invention.

FIG. 7 is another side plan view showing the operation of the suspension auxiliary device according to the preferred embodiment of the present invention.

### DETAILED DESCRIPTION

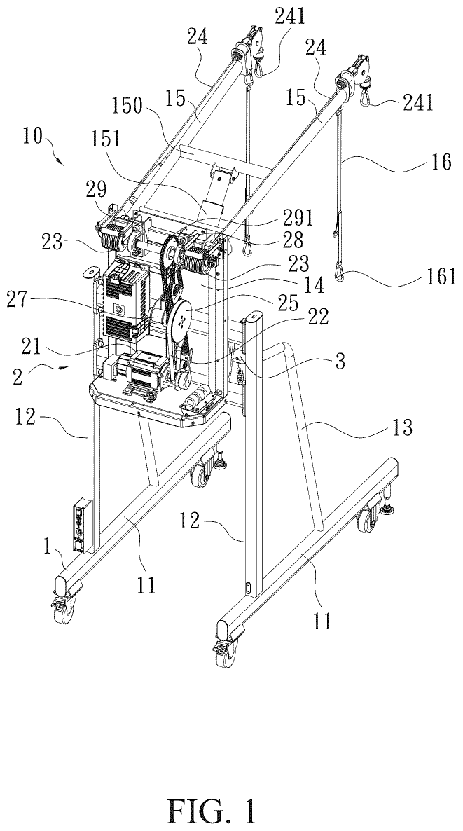

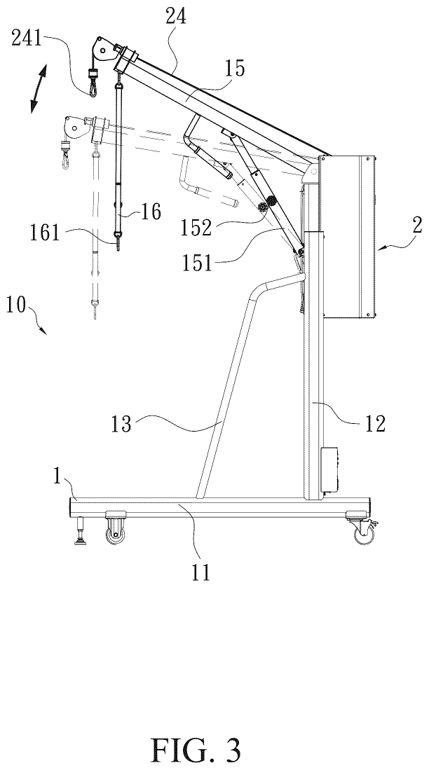

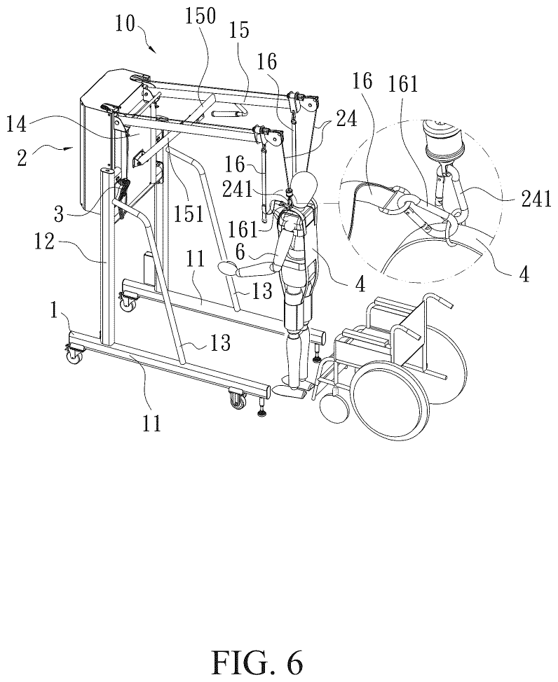

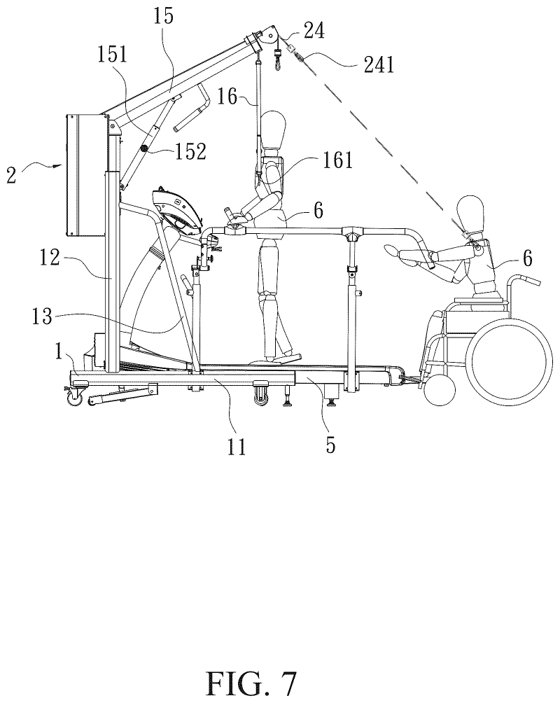

With reference to FIGS. 1-7, a suspension auxiliary device 10 according to a preferred embodiment of the present invention is applicable for a movable exercise apparatus 5 in a fixed state.

The suspension auxiliary device 10 comprises: a base 1, a transmission mechanism 2 mounted on the base 1 and having at least one hook 241 connected thereon to hook a sling carrier 4 of a user 6, such that the suspension auxiliary device 10 hangs and supports a part or a whole weight of the user 6, and the users 6 whose lower limbs cannot bear heavy weight can perform exercise or rehabilitation training on the movable exercise apparatus 5 by themselves. When the user 6 moves to a fixed operating position of the movable exercise apparatus 5, a value of a pulling force of at least one steel cable 24 is reset to adjust a support force appropriately based on a load-bearing capacity of the lower limbs of the user 6.

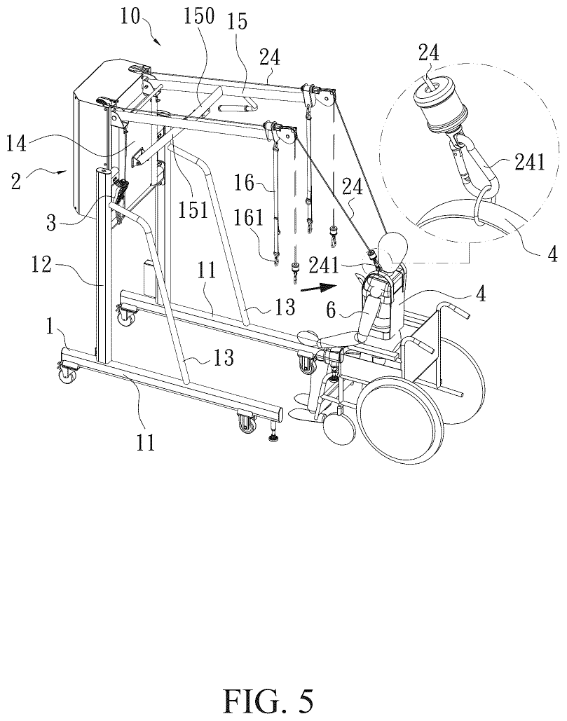

Referring to FIG. 1, the base 1 includes two spaced lower posts 11, each post 11 includes at least one stem 12 extending upward, two ribs 13 connected among the two spaced lower posts 11 and the at least one stem 12, a connection plate 14 connected between the two stem 12, two spaced rods 15 rotatably connected with two ends of the connection plate 14, wherein a coupling column 150 is fixed between the two spaced rods 15, an end of an adjustment column 151 is rotatably connected with a middle portion of the coupling column 150, and the other end of the adjustment column 151 is rotatably connected on the connection plate 14, wherein the adjustment column 151 is pulled via a fixing bolt 152 as shown in FIG. 5 so as to manually adjust a vertical moving position of the two spaced rods 15, and the fixing bolt 152 of the adjustment column 151 is fixed so that the two spaced rods 15 are fixed on a predetermined position.

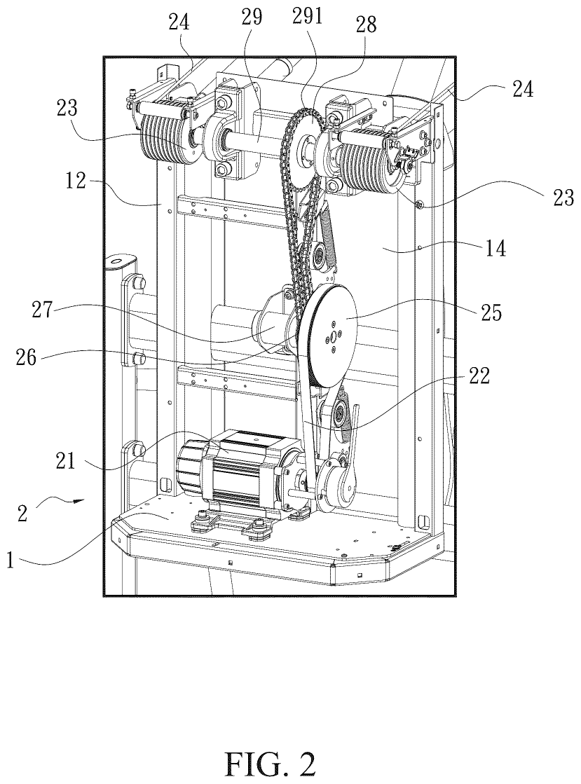

As shown in FIGS. 1 and 2, the transmission mechanism 2 includes a motor 21 configured to actuate a variable speed wheel 25 to rotate via a drive belt 22, wherein the variable speed wheel 25 is disposed on the base 1 and is coaxial with a small gear 26 which rotates simultaneously with the variable speed wheel 25, the variable speed wheel 25 and the small gear 26 are disposed on a first shaft 27 which is mounted on the base 1, and a gear chain 291 meshes with the small gear 26 and a drive wheel 28 which is fixed on a second shaft 29, wherein two cable pulleys 23 are mounted on two sides of the driven wheel 28 of the second shaft 29, and two steel cables 24 are rolled on the two cable pulleys 23, such that the two cable pulleys 23 actuate the two steel cables 24 to rotate upward and downward, wherein two outer ends of the two steel cables 24 are pulled outward along the two spaced rods 15 of the base 1, and two hooks 241 are secured on two distal ends of the two steel cables 24 and extended along the two rods 15 of the base 1.

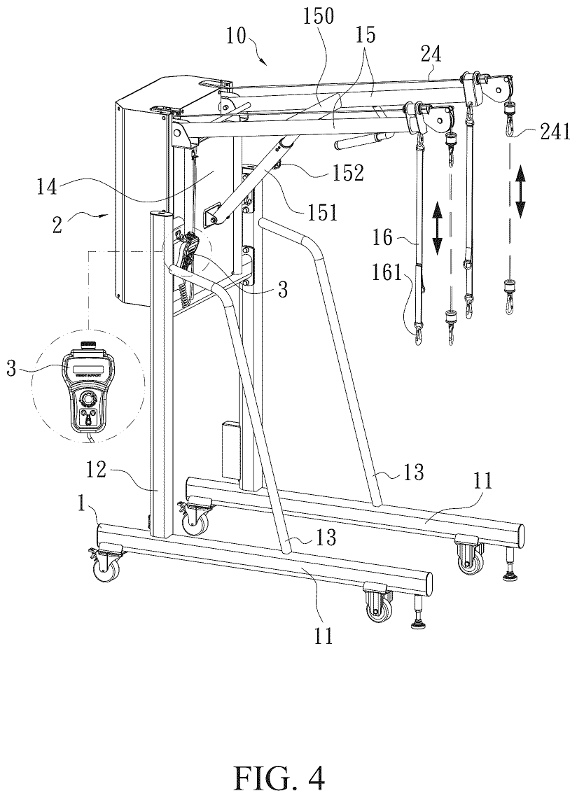

As illustrated in FIG. 4, a controller 3 located on the base 1 and configured to control the motor 21 to rotate, and the motor 21 drives the two steel cables 24 to roll or unroll, such that a desired length of the two steel cables 24 is adjustable. The pulling force of the two steel cables 24 is set by using the controller 3.

With reference to FIGS. 4-7, the two steel cables 24 of the transmission mechanism 2 are prolonged by using the controller 3, and the two hooks 241 of the two distal ends of the two steel cables 24 hook with the sling carrier 4 of the user 6, after the controller 3 controls the two steel cables 24 of the transmission mechanism 2 to pull or put the user 6, the user 6 moves forward, wherein an auxiliary strap 16 is connected on a distal end of each rod 15 so that a hook 161 of the auxiliary strap 16 hooks with the sling carrier 4 of the user 6, thus enhancing a safety protection of the user 6 to exercise or rehabilitate and avoiding a dropping of the user 6 as a breaking of the two steel cables 24.

When the user 6 moves to an operating position of the movable exercise apparatus 5, the value of the pulling force of the two steel cables 24 of the transmission mechanism 2 is reset by using the controller 3 of the suspension auxiliary device 10 so that the suspension auxiliary device 10 hangs the part or whole weight of the user 6, the using safety is enhanced, and the load-bearing capacity of the lower limbs of the user 6 is decreased, thus exercising or rehabilitating on the movable exercise apparatus 5 for the user 6, the lower limbs of which cannot bear his/her heavy weight.

The value of the pulling force of the two steel cables 24 of the suspension auxiliary device 10 is set by using the controller 3, and at least one sensor (not shown) is configured to sense a tension of the drive belt 22 or a chain of the transmission mechanism 2, thus controlling and setting the value of the pulling force of the two steel cables 24.

Thereby, the suspension auxiliary device 10 hangs and supports the part or whole weight of the user 6 so that the using safety of the user 6 is enhanced, and the load-bearing capacity of the lower limbs of the user 6 is decreased by using the suspension auxiliary device 10, thus exercising or rehabilitating on the movable exercise apparatus 5 for the user 6, the lower limbs of which cannot bear his/her heavy weight. When the user 6 moves to the operating position of the movable exercise apparatus 5, the value of the pulling force of the two steel cables 24 of the transmission mechanism 2 is adjustably reset based on the load-bearing capacity of the lower limbs of the user 6.

While the first embodiments of the invention have been set forth for the purpose of disclosure, modifications of the disclosed embodiments of the invention as well as other embodiments thereof may occur to those skilled in the art. The scope of the claims should not be limited by the first embodiments set forth in the examples, but should be given the broadest interpretation consistent with the description as a whole.

1. A suspension auxiliary device being applicable for a movable exercise apparatus in a fixed state and comprising a base;
wherein the base includes two spaced rods rotatably connected with two ends thereof, wherein a coupling column is fixed between the two spaced rods, an end of an adjustment column is rotatably connected a middle portion of the coupling column, and the other end of the adjustment column is rotatably connected on the base, wherein the adjustment column is pulled via a fixing bolt so as to manually adjust a vertical moving position of the two spaced rods, and the fixing bolt of the adjustment column is fixed so that the two spaced rods are fixed on a predetermined position;
wherein the base also includes a transmission mechanism, and the transmission mechanism has two hooks secured on two distal ends of two steel cables, the two hooks of the two steel cables hook with a sling carrier of a user, such that the suspension auxiliary device hangs and supports a part or a whole weight of the user, and the users whose lower limbs cannot bear a heavy weight can perform exercise or rehabilitation training on a movable exercise apparatus by themselves.

2. The suspension auxiliary device as claimed in claim 1, wherein the base includes two spaced lower posts, each post includes at least one stem extending upward, two ribs connected among the two spaced lower posts and the at least one stem, and a connection plate connected between the two stem.

3. The suspension auxiliary device as claimed in claim 2, wherein the transmission mechanism includes a motor configured to actuate a variable speed wheel to rotate via a drive belt, wherein the variable speed wheel is disposed on the base and is coaxial with a small gear which rotates simultaneously with the variable speed wheel, the variable speed wheel and the small gear are disposed on a first shaft which is mounted on the base, and a gear chain meshes with the small gear and a drive wheel which is fixed on a second shaft, wherein two cable pulleys are mounted on two sides of the driven wheel of the second shaft, and two steel cables are rolled on the two cable pulleys, such that the two cable pulleys actuate the two steel cables to rotate upward and downward, wherein two outer ends of the two steel cables are pulled outward along the two spaced rods of the base, and two hooks are secured on two distal ends of the two steel cables and extended along the two spaced rods of the base.

4. The suspension auxiliary device as claimed in claim 3, wherein a controller is located on the base and configured to control the motor to rotate, and the motor drives the two steel cables to roll or unroll, such that a desired length of the two steel cables is adjustable, and a pulling force of the two steel cables is set by using the controller.

5. The suspension auxiliary device as claimed in claim 3, wherein an auxiliary strap is connected on a distal end of each rod so that a hook of the auxiliary strap hooks with the sling carrier of the user.

6. The suspension auxiliary device as claimed in claim 4, wherein a value of the pulling force of the two steel cables of the suspension auxiliary device is set by using the controller, and at least one sensor is configured to sense a tension of the drive belt or a chain of the transmission mechanism.
